(19) United States
(12) Patent Application Publication
(10) Pub. No.: US 2003/0076021 A1
(43) Pub. Date: Apr. 24, 2003

(54) Electric light cooling sheath

(76) Inventor: Robert Desmond Woolford, Smithfield Plains (AU)

Correspondence Address: THE MAXHAM FIRM, 750 "B" STREET, SUITE 3100, SAN DIEGO, CA, 92101, US

(21) Appl. No.: 10/281,010

(22) Filed: Oct. 24, 2002

(30) Foreign Application Priority Data
Oct. 24, 2001 (AU) PR 8452

(51) Int. Cl. H01J 1/02

(52) U.S. Cl. 313/44

(57) ABSTRACT

An apparatus 1 for capturing heat from a light globe 9 is disclosed. The apparatus 1 comprises: a transparent or translucent internal sheath 19 adapted to fit around the globe 9, the internal sheath defining a first space 20; a transparent or translucent external sheath 29 mounted around and spaced from the internal sheath 19 so as to define a second space 30 between the sheaths; and an aperture 10 through the internal sheath 19 providing communication between the first and second spaces. A fluid inlet 4 and a fluid outlet 5 are provided to enable fluid to be circulated through the spaces to capture heat from the light globe 9.

### FIELD OF THE INVENTION

The present invention relates to an apparatus for capturing and/or redirecting heat energy emitted from electric light globes.

### BACKGROUND TO THE INVENTION

Electric light globes produce heat energy as well as light. However, in many applications it is not desirable to have the heat energy enter into the space in which the light is required. This presents a problem if conventional lights and light fittings are used alone.

When high wattage electric lights are used in indoor agricultural applications, the heating of the surrounding atmosphere by the lights makes it difficult to maintain the desired temperature necessary for healthy plant growth.

One simple solution to this problem is to supply fresh air and vent the heated air. However, this has the unwanted side effect of altering the composition of the indoor air. For instance, in a naturally aspirated indoor environment, venting increases indoor carbon dioxide levels. Alternatively, where the levels of carbon dioxide are desired to be high in the indoor environment and carbon dioxide is supplied (for instance from a pressurised cylinder or by the controlled burning of LPG), venting decreases indoor carbon dioxide levels.

In some circumstances it can be advantageous to provide a pressurised atmosphere in which to grow plants. To achieve a pressurised atmosphere, a sealed enclosure (such as a perspex sphere) may be used to separate the pressurised indoor air from the (lower pressure) outdoor air. With such a sealed enclosure, rejecting excess heat becomes even more problematic. It is therefore even more desirable to minimise the ingress of heat energy into the indoor environment (enclosure).

It is an object of the present invention to overcome at least some of the above-described problems.

### SUMMARY OF THE INVENTION

According to a first aspect of the invention there is provided an apparatus for capturing heat from a light globe comprising:

a transparent or translucent internal sheath adapted to fit around the globe, the internal sheath defining a first space having an open mouth;

a transparent or translucent external sheath mounted around and spaced from the internal sheath so as to define a second space between the sheaths;

an aperture through the internal sheath providing communication between the first and second spaces;

a fluid inlet means communicating with one of the spaces; and

a fluid outlet means communicating with the other of the spaces.

Generally a sealing means comprising resilient material adapted to engage a surface of the globe to which the sheath is attached will be provided. However in some applications, globes may be designed to sealably receive a sheath according to the invention and may include a resilient material adapted to engage a surface of the sheath.

Preferably the fluid inlet and outlet means are positioned adjacent the mouth. This ensures that a shadow is not cast over the active area of lighting produced by the globe.

According to a second aspect of the invention there is provided a light globe and heat extraction assembly comprising:

a light globe;

a transparent or translucent internal sheath fitted around the globe, the internal sheath defining a first space having an open mouth;

a transparent or translucent external sheath mounted around and spaced from the internal sheath so as to define a second space between the sheaths;

an aperture through the internal sheath providing communication between the first and second spaces;

a fluid inlet mean communicating with one of the spaces; and

a fluid outlet means communicating with the other of the spaces.

Preferably the assembly further comprises a sealing means between the mouth and the globe.

Preferably the fluid inlet and outlet means are positioned adjacent the mouth.

Preferably the assembly further comprises:

a heat exchange means communicating with both the fluid inlet means and the fluid outlet means; and

a mass of fluid contained within the spaces and the heat exchange means in a dosed loop,

wherein, in use, heat is transported from the globe to the heat exchange means.

Preferably the fluid is a gas.

Specific embodiments of the invention will now be described in some further detail with reference to and as illustrated in the accompanying figures. These embodiments are illustrative, and are not meant to be restrictive of the scope of the invention.

### DETAILED DESCRIPTION OF PREFERRED EMBODIMENTS OF THE INVENTION

Preferred embodiments of the invention are illustrated in the accompanying drawings wherein;

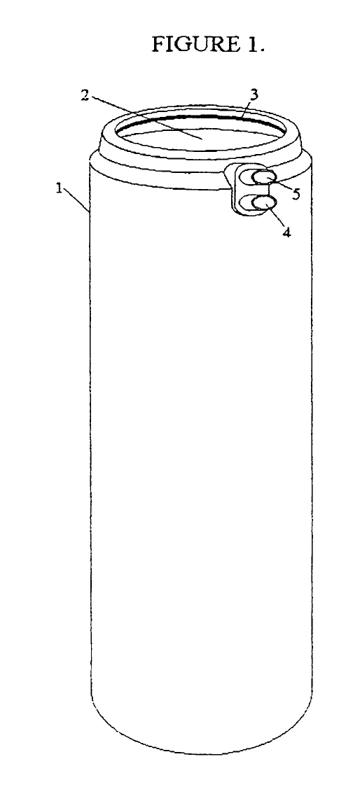

FIG. 1 shows a perspective view of an electric light cooling apparatus according to a first embodiment of the invention.

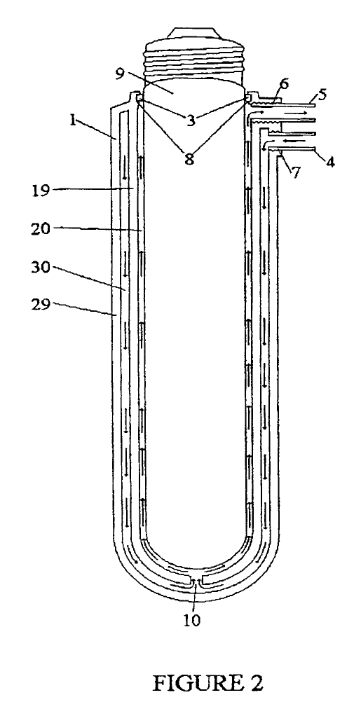

FIG. 2 shows a longitudinal cross-sectional view of the electric light cooling sheath of FIG. 1.

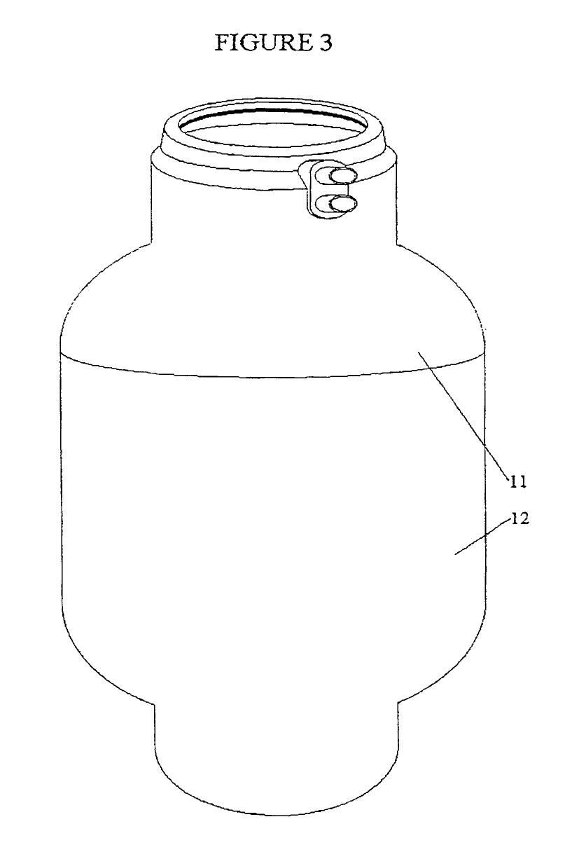

FIG. 3 shows a perspective view of an electric light cooling sheath according to a second embodiment of the invention.

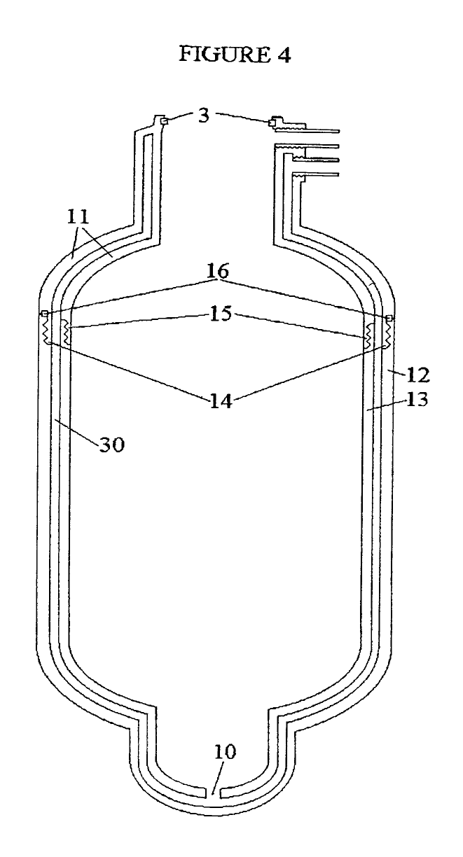

FIG. 4 shows a longitudinal cross-sectional view of the electric light cooling sheath of FIG. 3.

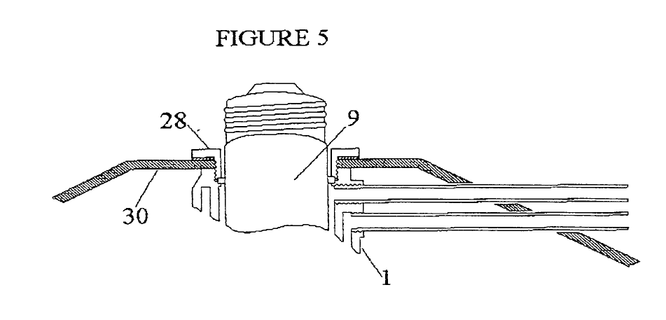

FIG. 5 shows a partial longitudinal cross-sectional view of the cooling sheath of FIGS. 1 and 2 modified to enable it to be sealably fitted to the ceiling of an enclosure or alternatively fitted with a reflector.

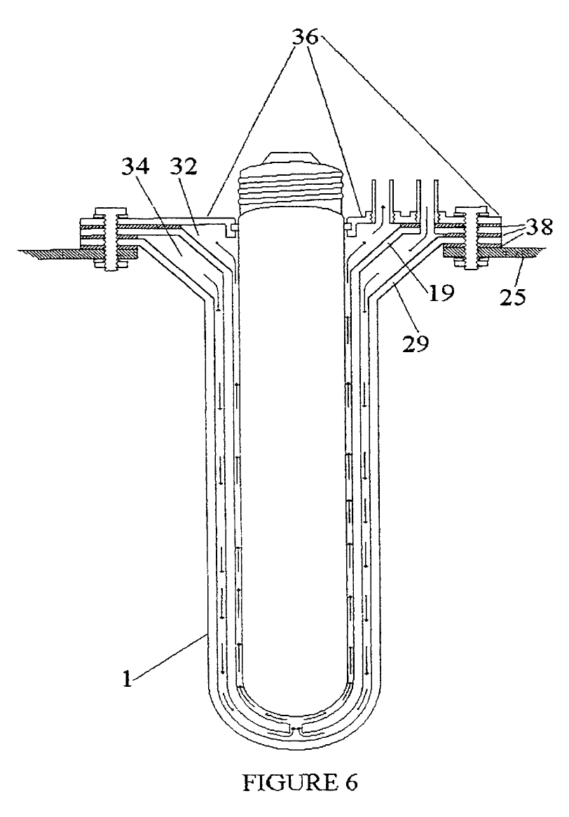

FIG. 6 shows a longitudinal cross-sectional view of an electric light cooling apparatus according to a third embodiment of the invention.

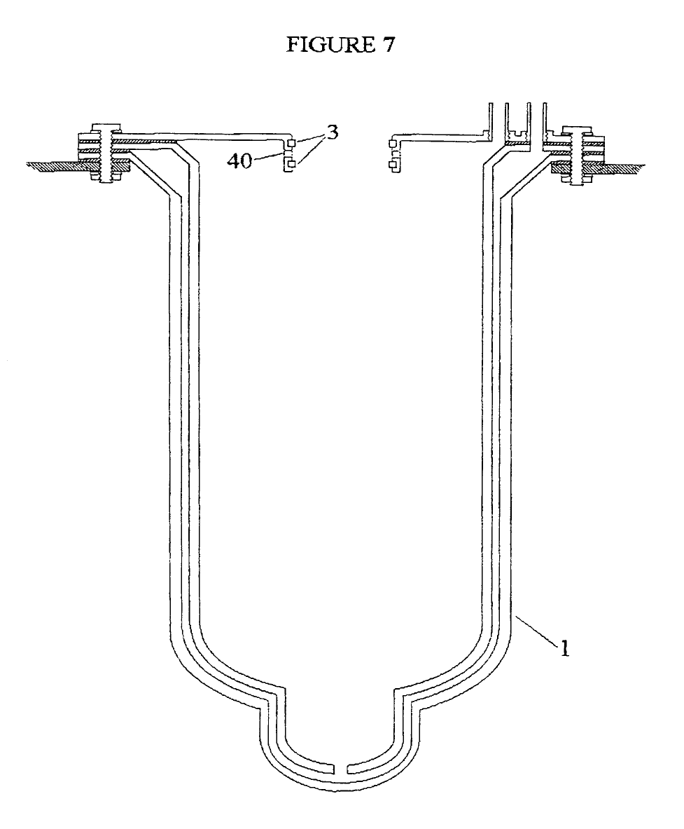

FIG. 7 shows a longitudinal cross-sectional view of an electric light cooling apparatus according to a forth embodiment of the invention.

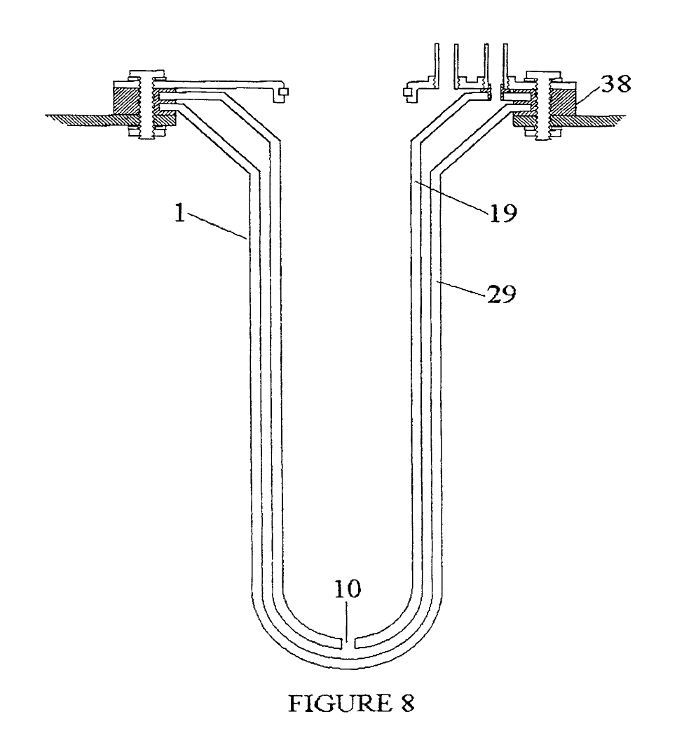

FIG. 8 shows a longitudinal cross-sectional view of an electric light cooling apparatus according to a fifth embodiment of the invention.

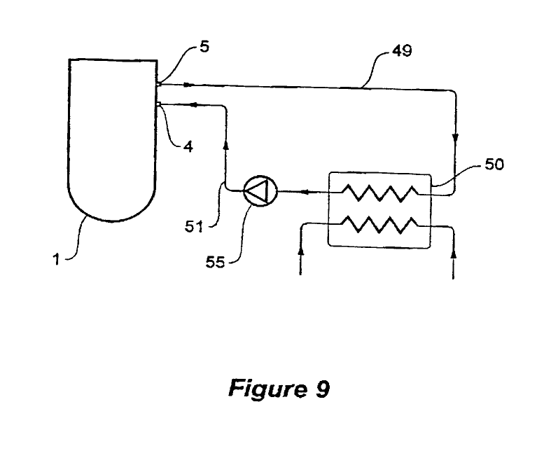

FIG. 9 shows a diagrammatic view of a closed loop assembly according to the invention.

The embodiments of the invention described below allow heat to be transferred from light globes to fluid, gas, typically independent of the surrounding atmosphere, thereby allowing both the temperature and carbon-dioxide levels of the surrounding atmosphere to be controlled with greater ease. This is particularly useful where high levels of carbon dioxide are required to be maintained in the indoor environment. The gas used to cool the light globe being heated significantly, may be pumped under pressure or extracted via a partial vacuum away from the lights to another environment, where the heat may be put to useful work.

The embodiments of the invention shown in FIGS. 1 to 5 operate by means of two transparent sheaths constructed of a rigid, transparent, heat resistant plastic or glass. The dimensions of the sheaths are such that one sheath is slightly larger than the light globe, such that the sheath and the light globe are separated by a small distance, thereby allowing the gas to flow around the light globe inside the sheath. The second outer sheath is slightly larger than the inner sheath so that a small gap exists therebetween whereby gas can flow between the sheaths. An aperture in the form of a small hole in the inner sheath allows the passage of gas from the space between the sheaths to the space between the inner sheath and the light globe.

Rigidly attached to the outer sheath are two pipe fittings, such that gas may be allowed to flow from one fitting to the space between the sheaths, then via the hole to the space between the inner sheath and the light globe, and then to the second of the pipe fittings, whereby the gas may flow through a hose attached to the second fitting away from the light globe and sheath.

The flow of gas may be accomplished either by a partial vacuum applied to the second fitting via the hose, or alternatively by gas pressure applied to the first fitting via a hose. In either case the gas pressure in the first fitting must be greater than the gas pressure in the second fitting, such that the flow of gas is first between the sheaths, and thereafter between the inner sheath and the light globe. With gas flowing in this direction, the temperature of the outer sheath is reduced.

Optionally, a closed loop system such as the one diagrammatically illustrated in FIG. 9 may be used. In such a system, the sheath 1 is connected to a heat exchange means in the form of a heat exchanger 50. A pump 55 circulates gas through the external sheath 29, the internal sheath 19 and the heat exchanger 50 to extract heat from the globe 9.

In an alternative arrangement pump 55 may be a vacuum pump positioned in the outlet line 49 instead of the inlet line 51

The pipefittings and hoses are positioned in such a way as to not cast a shadow over the active area of lighting produced by the light globe.

Both sheaths are rigidly joined such that the gas between the sheaths may not pass directly out to the atmosphere. The inner sheath is joined to the light globe by means of a flexible rubber-sealing ring which is fitted tightly into a recess in the inner surface of the inner sheath.

The rubber seal ring may be rectangular or any other shape in cross-section, provided that the shape provides an effective gas seal between the cooling gas on one side, and the atmosphere on the other side.

In one embodiment of the invention, the shape of the sheath is that of a rod, whereby a rod-shaped light globe may be inserted into the sheath through the sealing ring, the rod-shape being common amongst 200 watt, 400 watt and 600 watt High Intensity Discharge light globes.

In a second embodiment of the invention, the sheath is in the shape of a bulb, wherein the sheath is constructed in two halves joined by means of a screw thread, such that a bulb shaped light globe may be inserted inside one half of the sheath and the second half screwed on thereafter, the bulb shape being common amongst 1000 watt High Intensity Discharge light globes.

The construction of the two embodiments of the invention shown in FIGS. 1 to 2 and 3 to 4 respectively will now be described in further detail.

Referring to FIG. 1 it can be seen that in this embodiment sheath fitting 1 accommodates a rod-shaped light globe, which would be inserted into the sheath through open mouth 2 such that the screw fitting and electric terminal of the light globe may protrude out of the sheath, whilst the globe is positioned inside the sheath. Rubber sealing ring 3 holds the globe in place, and provides a barrier between the cooling gas inside the sheath and the atmosphere.

Fluid inlet pipe fitting 4 allows the flow of cooling gas into the sheath via an attached hose, whilst fluid outlet pipe fitting 5 allows the flow of cooling gas out of the sheath via an attached hose.

It can be seen that the position of the fittings 4 and 5 adjacent the open mouth 2 of the sheath will avoid a shadow being cast by the fittings over the useful working area of lighting.

Referring to FIG. 2, sheath fitting 1 has a transparent internal sheath 19 which is shaped to fit around a globe (for example, the rod-shaped globe 9 of FIG. 2). The sealing ring 3 provides a seal between the inner wall of sheath 19 and globe 9 to define a first hollow space 20. An external sheath 29 is mounted around and spaced from internal sheath 19 so as to define a second hollow space 30. Sealing ring 3 is fitted into an annular recess 8 formed in the inner wall of sheath 19 adjacent its upper end. Pipe fitting 4 is attached to the sheath via thread 7 while pipe fitting 5 is attached to the sheath via thread 6. Arrows show the direction of the flow of the cooling gas from pipe fitting 4 through aperture 10 to pipe fitting 5.

Referring to FIG. 3 it can be seen that in this second embodiment, the sheath consists of two external sections 11 and 12 in order to accommodate an electric light globe in the shape of a bulb. The pipe fittings, sealing ring and aperture remain similar to those described in FIG. 1.

Referring to FIG. 4 it can be seen that the shape of the sheath is bulbous to accommodate a bulb-shaped light globe. The sheath 13 and 19 comprise a pair of sealably joinable separable portions. Both inner and outer sheath portions 11 are joined in one part of the sheath, and completed by the addition of inner sheath portion 13 by means of thread 15, and outer sheath portion 12 by means of thread 14. A second sealing ring 16 is provided to contain the cooling gas within the second hollow space 30. The pipe fittings and threads, sealing ring 3, aperture and flow of cooling gas remain similar to those described in FIG. 2.

Where a pressurised atmosphere is provided, the sheath of the first embodiment of the present invention may be modified to enable it to be sealably fitted into the wall of the pressure vessel employed. FIG. 5 shows such a sheath in partial longitudinal cross-section.

The modified sheath shown in FIG. 5 has a similar construction as that of the sheath of FIGS. 1 and 2 with the addition of means for enabling it to be readily fitted to a hole within a ceiling of an enclosure or alternatively to be fitted with a reflector 30 into the pressure vessel. Threaded connection 28 secures reflector 30 in position at the upper end of sheath 1 to reflect light (and heat) downwards.

A third embodiment of the invention is shown in FIG. 6. The internal sheath 19 and the external sheath 29 are shaped to facilitate blow moulding and include plenum chambers 32 and 34 respectively. A non transparent and reflective material 36 is used at the top of sheath 1 as shown in FIG. 6. Rubber seals 38 are provided as shown in FIG. 6. FIG. 7 shows a fourth embodiment of the invention which is also adapted to facilitate production from a blow moulding process. A pair of seals are provided for added globe stability and a hole 40 between the seals 3 is provided to prevent hot spots forming between the seals.

In a fifth embodiment of the invention shown in FIG. 8 moulded seals 38 are provided to allow the use of glass or plastic. By avoiding penetrations through the internal and external sheaths 19 and 29 (other than aperture 10) stresses are reduced.

While generally it is envisaged that sheaths according to the invention will be made to fit existing globes, it is also possible for globe manufacturers to redesign their globes to facilitate fitment of sheaths according to the invention. In such cases, the seal between the sheath and the globe (eg seal 3 in the embodiments described above) may be optionally provided on the globe rather than on the sheath.

While the present invention has been described in terms of preferred embodiments in order to facilitate better understanding of the invention, it should be appreciated that various modifications can be made without departing from the principles of the invention. Therefore the invention should be understood to include all such modifications within its scope.

The claims defining the invention are as follows:

1. An apparatus for capturing heat from a light globe comprising:
a transparent or translucent internal sheath adapted to fit around the globe, the internal sheath defining a first space having an open mouth;
a transparent or translucent external sheath mounted around and spaced from the internal sheath so as to define a second space between the sheaths;
an aperture through the internal sheath providing communication between the first and second spaces;
a fluid inlet means communicating with one of the spaces; and
a fluid outlet means communicating with the other of the spaces.

2. An apparatus as claimed in claim 1 further comprising a sealing surface adapted to provide a seal between the mouth and the globe.

3. An apparatus as claimed in claim 2 wherein the sealing surface comprises a resilient material adapted to engage an external surface of the globe.

4. An apparatus as claimed in claim 3 wherein the fluid inlet and outlet means are positioned adjacent the mouth.

5. An apparatus as claimed in claim 4 wherein the internal sheath is rod shaped.

6. An apparatus as claimed in claim 4 wherein each of the sheaths comprise a pair of sealably joinable separable portions.

7. An apparatus as claimed in claim 6 wherein the respective pairs of portions are joinable at threaded ends.

8. An apparatus for capturing heat from a light globe comprising:
a transparent or translucent internal sheath adapted to fit around the globe, the internal sheath defining a first space having an open mouth;
a transparent or translucent external sheath mounted around and spaced from the internal sheath so as to define a second space between the sheaths;
an aperture through the internal sheath providing communication between the first and second spaces;
a fluid inlet means communicating with one of the spaces;
a fluid outlet means communicating with the other of the spaces; and
sealing surface adapted to provide a seal between the mouth and the globe,
wherein the fluid inlet and outlet means are positioned adjacent the mouth.

9. An apparatus as claimed in claim 8 wherein the internal sheath is rod shaped.

10. An apparatus as claimed in claim 8 wherein each of the sheaths comprise a pair of sealably joinable separable portions.

11. An apparatus as claimed in claim 10 wherein the respective pairs of portions are joinable at threaded ends.

12. A light globe and heat extraction assembly comprising:
a light globe;
a transparent or translucent internal sheath fitted around the globe, the internal sheath defining a first space having an open mouth;
a transparent or translucent external sheath mounted around and spaced from the internal sheath so as to define a second space between the sheaths;
an aperture through the internal sheath providing communication between the first and second spaces;
a fluid inlet means communicating with one of the spaces; and
a fluid outlet means communicating with the other of the spaces.

13. An assembly as claimed in claim 12 further comprising a sealing means between the mouth and the globe.

14. An assembly as claimed in claim 13 wherein the fluid inlet and outlet means are positioned adjacent the mouth.

15. An assembly as claimed in claim 14 further comprising:
a heat exchange means communicating with both the fluid inlet means and the fluid outlet means; and
a mass of fluid contained within the spaces and the heat exchange means in a dosed loop,
wherein, in use, heat is transported from the globe to the heat exchange means.

16. An assembly as claimed in claim 15 wherein the fluid is a gas.

17. An apparatus substantially as hereinbefore described with reference to and as illustrated in the accompanying FIGS. 1 and 2, 3 and 4, 5, 5 and 7, or 8.
